(19) United States
(12) Patent Application Publication
(10) Pub. No.: US 2026/0286251 A1
(43) Pub. Date: Sep. 24, 2026

(54) CLEANING COMPOSITION AND METHOD FOR MAINTAINING BUILD SURFACE IN AN ADDITIVE MANUFACTURING PROCESS

(71) Applicant: David Wetherington, GOLDEN, CO (US)

(72) Inventor: David Wetherington, GOLDEN, CO (US)

(21) Appl. No.: 19/379,513

(22) Filed: Nov. 4, 2025

(51) Int. Cl. C11D 1/88

(52) U.S. Cl. CPC C11D 1/88

(57) ABSTRACT

The present disclosure provides a cleaning composition for polymeric build surfaces in additive manufacturing. The cleaning composition includes at least one surfactant, a buffering system, and an aqueous carrier. In addition, the buffering system includes at least one buffering agent selected from at least one of organic acids, inorganic acids, and salts thereof. Further, the cleaning composition has a pH in the range of about 1 to 7. Furthermore, the cleaning composition maintains integrity of the polymeric build surface during repeated cleaning cycles while removing printing residues.

### TECHNICAL FIELD

The present disclosure relates to the field of additive manufacturing and, in particular, relates to cleaning composition and method for maintaining build surface in an additive manufacturing process.

### BACKGROUND

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Additive manufacturing technologies, commonly known as three-dimensional printing, have become widely adopted for producing physical objects from digital models. In fused filament fabrication processes, thermoplastic materials are melted and deposited layer by layer onto a build surface. The build surface, also referred to as a build plate or print bed, serves as the foundation for the printing process. The first layers of printed material must adhere properly to the build surface for successful printing. Good adhesion is essential for achieving successful print outcomes and dimensional accuracy of finished parts.

Various polymeric materials are employed as build surfaces in fused filament fabrication systems. Polyetherimide sheets and films are commonly used due to their favorable thermal properties and adhesion characteristics. Composite polymeric laminates comprising materials such as polycarbonate or acrylic are also widely utilized as build surfaces. These laminates are often bonded to rigid or flexible substrates and may feature textured surfaces to enhance adhesion. The performance and longevity of these polymeric build surfaces directly impact print quality and operational costs.

During repeated printing operations, build surfaces accumulate various contaminants including oils, polymer residues, debris, and the like. Regular cleaning of build surfaces is necessary to maintain adequate adhesion properties and ensure consistent print quality. Current maintenance practices typically involve cleaning these surfaces with readily available household cleaning products. Common cleaning products include dish soaps, general-purpose detergents, and isopropyl alcohol. These conventional cleaning products are formulated to have a basic pH, typically in the range of 8 to 10.

Polymeric materials such as polyetherimide and polycarbonate are susceptible to chemical degradation when exposed to alkaline conditions. When subjected to solutions having elevated pH levels, these materials can undergo base catalyzed hydrolysis. This hydrolytic process causes breaking of polymer chains and deterioration of material properties. Repeated exposure to mildly basic cleaning solutions leads to progressive deterioration of the polymeric build surfaces. The deterioration manifests as embrittlement, surface degradation, and loss of material integrity over time.

The degradation of polymeric build surfaces results in diminished adhesion performance and reduced print quality. Users experience increased print failures and are compelled to replace build surfaces more frequently than necessary. The premature replacement of build plates increases operational costs and generates waste.

In light of the foregoing discussion, there exists a need for an effective cleaning composition that can remove contaminants without inducing chemical degradation.

### SUMMARY

Before the present system and method and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present disclosure. This summary is not intended to identify essential features of the claimed subject matter nor is it intended for use in detecting or limiting the scope of the claimed subject matter.

In an aspect, a cleaning composition for polymeric build surfaces in additive manufacturing is disclosed. The cleaning composition includes at least one surfactant, a buffering system, and an aqueous carrier. In addition, the buffering system includes at least one buffering agent selected from at least one of organic acids, inorganic acids, and salts thereof. Further, the cleaning composition has a pH in the range of about 1 to 7. Furthermore, the cleaning composition maintains integrity of the polymeric build surface during repeated cleaning cycles while removing printing residues.

In an embodiment, the surfactant concentration is in a range of about 0.5% to 30% by weight of the total composition.

In another embodiment, the buffering system concentration is in a range of about 0.5% to 30% by weight of the surfactant concentration.

In yet another embodiment, the aqueous carrier concentration is in a range of about 5% to 99% by weight of the total composition.

In yet another embodiment, the at least one surfactant is selected from at least one of anionic surfactants, nonionic surfactants, and amphoteric surfactants.

In yet another embodiment, the anionic surfactant is selected from at least one of sodium lauryl sulfate, sodium laureth sulfate, and alkyl sulfates.

In yet another embodiment, the nonionic surfactant is selected from at least one of alkyl glucosides, polysorbates, and ethoxylated alcohols.

In yet another embodiment, the amphoteric surfactant comprises lauramine oxide.

In yet another embodiment, the buffering system includes at least one of citric acid, sodium citrate, acetic acid, sodium acetate, phosphoric acid, sodium phosphate, lactic acid, and sodium lactate.

In yet another embodiment, further includes at least one additive selected from at least one of urea, sodium chloride, fumed silica, preservatives, and fragrances.

In yet another embodiment, the composition is formulated as a solid, liquid, gel, paste, or foam.

In yet another embodiment, the polymeric build surface comprises polyetherimide (PEI).

In yet another embodiment, the polymeric build surface includes a composite polymeric laminate. In addition, the composite polymeric laminate includes at least one polymer selected from at least one of polycarbonate, acrylic polymers, and blends thereof.

In yet another embodiment, the cleaning composition removes contaminants includes at least one of polymer residues, oils, adhesives, and particulate debris from the polymeric build surface.

In yet another embodiment, the composition prevents base-catalyzed hydrolysis of the polymeric build surface that occurs with cleaning compositions having a pH above 7

### DETAILED DESCRIPTION

Reference will now be made in more detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of embodiments of the present description. As used herein, the term “and/or” includes any and all combinations of one or more of the associated listed items. Throughout the present disclosure, the expression “at least one of a, b and c” indicates only a, only b, only c, both a and b, both a and c, both b and c, all of a, b, and c, or variations thereof.

The subject matter of the present disclosure may include various modifications and various embodiments, and example embodiments will be illustrated in the drawings and described in more detail in the detailed description. Effects and features of the subject matter of the present disclosure, and implementation methods therefor will become clear with reference to the embodiments described herein below together with the drawings. The subject matter of the present disclosure may, however, be embodied in many different forms and should not be construed as limited to the embodiments set forth herein.

Hereinafter, embodiments of the present disclosure will be described in more detail with reference to the accompanying drawings. The same or corresponding elements will be denoted by the same reference numerals, and thus, redundant description thereof will not be repeated.

It will be understood that although the terms “first,” “second,” etc. may be used herein to describe various elements, these elements should not be limited by these terms. These terms are only used to distinguish one element from another.

An expression used in the singular may also encompasses the expression of the plural, unless it has a clearly different meaning in the context.

In the following embodiments, it is to be understood that the terms such as “including,” “includes,” “having,” “comprises,” and “comprising,” are intended to indicate the existence of the features or elements disclosed in the specification, and are not intended to preclude the possibility that one or more other features or elements may exist or may be added.

An objective of the present disclosure is to provide a cleaning composition and method for maintaining build surface in an additive manufacturing process.

Another objective of the present disclosure is to prevent base-catalyzed hydrolysis of polymeric build surfaces during cleaning operations.

Yet another objective of the present disclosure is to extend the functional lifetime of polyetherimide and polycarbonate-based build surfaces.

Yet another objective of the present disclosure is to maintain adhesion performance of build surfaces through repeated cleaning cycles.

Yet another objective of the present disclosure is to remove polymer residues, oils, and contaminants effectively while preserving material integrity.

Yet another objective of the present disclosure is to provide a cleaning formulation that is safe for user handling and compatible with polymeric materials susceptible to alkaline degradation.

In an example aspect, the present disclosure provides the cleaning composition for polymeric build surfaces in additive manufacturing. The cleaning composition may include at least one surfactant, a buffering system, and an aqueous carrier. The buffering system that may include at least one buffering agent selected from at least one of organic acids, inorganic acids, and salts thereof. The cleaning composition has a pH in the range of about 1 to 7. The cleaning composition maintains integrity of the polymeric build surface during repeated cleaning cycles while removing printing residues.

In an embodiment, it has been discovered that polymeric build surfaces are degraded by solutions with a basic pH. All soaps currently on the market and recommended for cleaning build surfaces are basic, typically having a pH of 8 to 10. Even though these pH levels are considered only mildly basic, repeated exposure causes degradation of the build surfaces. The present cleaning composition with an acidic pH works much better than conventional basic cleaning products. The acidic nature of the composition distinguishes it from existing cleaning products.

In another embodiment, the polymeric build surface may include polyetherimide (PEI). Polyetherimide is an amorphous thermoplastic material widely used for its adhesion properties and thermal stability. PEI may include Ultem-type materials and similar thermoplastic polyetherimide films or plates. PEI coatings used on three-dimensional print beds are slowly harmed in an alkaline or basic environment. Repeated use of standard soaps with basic pH degrades these PEI surfaces through base-catalyzed hydrolysis.

In yet another embodiment, the polymeric build surface may include a composite polymeric laminate. The composite polymeric laminate may include at least one polymer selected from at least one of polycarbonate, acrylic polymers, and blends thereof. These composite laminates may be adhered to rigid or flexible substrates. The laminates may feature textured surfaces engineered for fused filament fabrication adhesion. Like PEI, polycarbonate and acrylic materials are susceptible to degradation when exposed to basic pH conditions.

In an example implementation, the surfactant concentration is in a range of about 0.5% to 30% by weight of the total composition. The surfactant provides the cleaning action to remove contaminants from the build surface. In some examples, different surfactant concentrations may be selected based on the cleaning requirements and formulation type.

In another example aspect, the buffering system maintains the pH within the specified range during storage and use. The buffering system prevents pH drift that could move the composition outside the protective pH range. The buffering system concentration may be selected to provide adequate buffering capacity for the intended application. In an embodiment, the buffering system concentration is in a range of about 0.5% to 30% by weight of the surfactant concentration.

In an example embodiment, the aqueous carrier serves as the primary solvent for the composition. The aqueous carrier may include water suitable for formulation purposes. The aqueous carrier dissolves or disperses the other components of the cleaning composition. In an embodiment, the aqueous carrier concentration is in a range of about 5% to 99% by weight of the total composition.

In some embodiments, the at least one surfactant is selected from at least one of anionic surfactants, nonionic surfactants, and amphoteric surfactants. Each surfactant type provides different cleaning properties and compatibility characteristics. Combinations of different surfactant types may be employed to optimize cleaning performance.

In an exemplary embodiment, the anionic surfactant is selected from at least one of sodium lauryl sulfate, sodium laureth sulfate, alkyl sulfates, and the like. These anionic surfactants provide effective removal of oily residues and polymer contaminants. The anionic surfactants function effectively within the acidic pH range of the composition.

In another exemplary embodiment, the nonionic surfactant is selected from at least one of alkyl glucosides, polysorbates, ethoxylated alcohols, and the like. Alkyl glucosides such as decyl glucoside provide gentle cleaning action while maintaining material compatibility. The nonionic surfactants are stable across the pH range and do not contribute to pH changes.

In yet another exemplary embodiment, the amphoteric surfactant may include lauramine oxide. Amphoteric surfactants provide enhanced foam stability and cleaning performance across the specified pH range. These surfactants maintain their effectiveness in both slightly acidic and neutral conditions.

In an example aspect, the buffering system may include at least one of citric acid, sodium citrate, acetic acid, sodium acetate, phosphoric acid, sodium phosphate, lactic acid, sodium lactate, and the like. In an embodiment, citric acid and sodium citrate may be particularly suitable buffering agents. The combination of citric acid and sodium citrate provides effective buffering in the pH range of about 1 to 7. The buffering system ensures the composition remains within the pH range that prevents degradation of the polymeric build surfaces.

In another example implementation, the cleaning composition may further include at least one additive selected from at least one of urea, sodium chloride, fumed silica, preservatives, fragrances, and the like. In an example, urea may function as a solubilizer to enhance the dissolution of polymer residues. In some examples, sodium chloride may be included as a thickening agent to adjust viscosity. In one example, fumed silica, also known as cabosil, may be incorporated to create paste formulations. Preservatives prevent microbial growth during storage. Fragrances provide pleasant odor characteristics.

In an exemplary embodiment, the composition is formulated as a solid, liquid, gel, paste, or foam. In one example, liquid formulations provide easy application through spraying or wiping. In another example, gel formulations adhere to vertical surfaces for extended contact time. In yet another example, paste formulations allow targeted application to specific areas. In some examples, foam formulations provide increased surface coverage with minimal product use. In an example, solid formulations may be in a form of a soap or similar form factor.

In an example aspect, the cleaning composition removes contaminants that may include at least one of polymer residues, oils, adhesives, and particulate debris from the polymeric build surface. Polymer residues may include thermoplastic materials deposited during printing operations. These materials may include PLA, ABS, PETG, nylon, and the like. Oils may include fingerprints, lubricants, and processing aids. Adhesives may include glue stick residues, hairspray deposits, and other adhesion promoters applied to enhance print adhesion.

In an embodiment, the composition prevents base-catalyzed hydrolysis of the polymeric build surface that occurs with cleaning compositions having a pH above 7. Base-catalyzed hydrolysis causes chain scission in polyetherimide and polycarbonate materials. This degradation mechanism leads to embrittlement and loss of mechanical properties. Surface deterioration manifests as reduced adhesion performance and eventual failure of the build surface. The controlled pH range of about 4 to 7 suppresses this hydrolytic degradation pathway.

In an example implementation, the cleaning composition is safe to use on skin. For example, human skin has a pH of around 4.5 to 5, so the acidic nature of the composition is compatible with skin contact. This compatibility reduces the risk of irritation during handling. The composition does not require extensive personal protective equipment like strongly acidic or basic cleaners.

In some embodiments, the present cleaning composition addresses a gap in the market. It is almost impossible to find simple soaps that are slightly acidic. No similar acidic soaps are available in the market, and certainly none targeted specifically at three-dimensional printing build surfaces. The present cleaning composition fills this unmet need for a specialized cleaning product designed for polymeric build surfaces.

In yet another example aspect, the acidic cleaning composition not only preserves the build surfaces but also happens to clean better in these specific applications. The acidic pH enhances the removal of certain contaminants commonly found on build surfaces. The cleaning performance is superior to conventional basic soaps while simultaneously protecting the surface from degradation.

In an example implementation, the method of using the cleaning composition may include applying the composition to the polymeric build surface. The composition may be applied through spraying, wiping, or immersion. After application, the surface may be wiped or rinsed to remove dissolved contaminants. The process may be repeated as necessary for thorough cleaning.

Further, regular cleaning with the pH-controlled composition maintains consistent adhesion properties of the build surface. Print failures due to poor adhesion are reduced. The need for frequent build surface replacement is eliminated. Operational costs are reduced through extended build surface lifetime.

In an embodiment, the cleaning composition may be used as part of regular printer maintenance. The composition may be applied between print jobs to remove residues. It may be used for deep cleaning when adhesion problems are observed.

In an exemplary embodiment, the cleaning composition maintains its effectiveness through repeated use. Unlike conventional basic cleaners that cause progressive degradation, the acidic composition preserves surface integrity. Build surfaces cleaned with the composition retain their adhesion performance over extended periods. The functional lifetime of the build surface is significantly prolonged compared to cleaning with soaps at pH 8 to 10.

In some embodiments, the cleaning composition provides consistent results across different types of polymeric build surfaces. PEI sheets respond well to the acidic cleaning without degradation. Polycarbonate laminates maintain their properties after repeated cleaning. Acrylic-based surfaces show no signs of chemical attack from the composition.

The cleaning composition as disclosed in the disclosure provides the following non-limiting advantages:
Extended functional lifetime of polymeric build surfaces through prevention of alkaline degradation.
Superior cleaning performance compared to conventional basic soaps while protecting surface integrity.
Compatibility with human skin due to pH alignment with natural skin pH.
Fills market gap for acidic cleaning products specifically designed for three-dimensional printing applications.
Maintained adhesion performance through repeated cleaning cycles without surface deterioration.
Effective removal of polymer residues, oils, and contaminants at pH levels safe for PEI and polycarbonate materials.
Reduced operational costs through decreased frequency of build surface replacement.
Prevention of base-catalyzed hydrolysis that occurs with pH 8 to 10 cleaning products.

In light of the above mentioned advantages and the technical advancements provided by the disclosed method and/or cleaning composition, the claimed steps as discussed above are not routine, conventional, or well understood in the art, as the claimed steps enable the following solutions to the existing problems in conventional technologies. Further, the claimed steps clearly bring an improvement in the functioning of the cleaning composition itself as the claimed steps and the constructional features of the cleaning composition provide a technical solution to a technical problem.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the scope of the present disclosure as defined by the following claims, and equivalents thereof.

What is claimed is:

1. A cleaning composition for polymeric build surfaces in additive manufacturing, the cleaning composition comprising:
at least one surfactant;
a buffering system comprises at least one buffering agent selected from at least one of organic acids, inorganic acids, and salts thereof; and
an aqueous carrier,
wherein the cleaning composition has a pH in the range of about 1 to 7, and wherein the cleaning composition maintains integrity of the polymeric build surface during repeated cleaning cycles while removing printing residues.

2. The cleaning composition of claim 1, wherein the surfactant concentration is in a range of about 0.5% to 30% by weight of the total composition.

3. The cleaning composition of claim 1, wherein the buffering system concentration is in a range of about 0.5% to 30% by weight of the surfactant concentration.

4. The cleaning composition of claim 1, wherein the aqueous carrier concentration is in a range of about 5% to 99% by weight of the total composition.

5. The cleaning composition of claim 1, wherein the at least one surfactant is selected from at least one of anionic surfactants, nonionic surfactants, and amphoteric surfactants.

6. The cleaning composition of claim 5, wherein the anionic surfactant is selected from at least one of sodium lauryl sulfate, sodium laureth sulfate, and alkyl sulfates.

7. The cleaning composition of claim 5, wherein the nonionic surfactant is selected from at least one of alkyl glucosides, polysorbates, and ethoxylated alcohols.

8. The cleaning composition of claim 5, wherein the amphoteric surfactant comprises lauramine oxide.

9. The cleaning composition of claim 1, wherein the buffering system comprises at least one of citric acid, sodium citrate, acetic acid, sodium acetate, phosphoric acid, sodium phosphate, lactic acid, and sodium lactate.

10. The cleaning composition of claim 1, further comprising at least one additive selected from at least one of urea, sodium chloride, fumed silica, preservatives, and fragrances.

11. The cleaning composition of claim 1, wherein the composition is formulated as a solid, liquid, gel, paste, or foam.

12. The cleaning composition of claim 1, wherein the polymeric build surface comprises polyetherimide (PEI).

13. The cleaning composition of claim 1, wherein the polymeric build surface comprises a composite polymeric laminate, wherein the composite polymeric laminate comprises at least one polymer selected from at least one of polycarbonate, acrylic polymers, and blends thereof.

14. The cleaning composition of claim 1, wherein the cleaning composition removes contaminants comprises at least one of polymer residues, oils, adhesives, and particulate debris from the polymeric build surface.

15. The cleaning composition of claim 1, wherein the composition prevents base-catalyzed hydrolysis of the polymeric build surface that occurs with cleaning compositions having a pH above 7.
